(19) United States
(12) Patent Application Publication
(10) Pub. No.: US 2008/0199831 A1
(43) Pub. Date: Aug. 21, 2008

(54) Process and Device For Cleaning Teeth With Sonic Energy

(76) Inventors: Klaus Teichert, Pullach (DE); Elmar Grandy, Oberschleissheim (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 11/913,955

(22) PCT Filed: Apr. 21, 2006
(86) PCT No.: PCT/EP2006/003711

§ 371 Date: Mar. 18, 2008

(30) Foreign Application Priority Data
May 9, 2005 (DE) 10 2005 021 261.1

(51) Int. Cl. A61C 15/00; A61C 1/07

(52) U.S. Cl. 433/216; 433/119

(57) ABSTRACT

A process and device are disclosed for cleaning teeth with sonic energy, in particular audible sound or ultrasound. Sound is conducted to the teeth (5) through a liquid (6) in an oral cavity (3). Sound is applied from the outer side (2) of the oral cavity (3).

The invention concerns a method for cleaning teeth and a device to carry out the same, in accord with the preambles of the independent claims, whereby the cleaning of teeth is accomplished by the use of sound in the audible or ultrafrequency ranges.

Disclosure has been made, that cleaning of hard surfaces of objects can be carried out by a movement induced within an audible region of sound or by a cavitation induced with ultrasound. This is true particularly in the case of exposure to ultrasound which is transported by a liquid medium to the contaminated surfaces. Where the cleaning of teeth is concerned, the application of ultrasound offers special advantages, since by ultrasound treatment, a cleaning of not easily accessible surfaces becomes possible. However, the application of the said ultrasound to the teeth has been considered difficult, because between the source of the ultrasound and the surfaces to be cleaned, a connection capable of carrying ultrasound must be provided.

DE 199 16 156 A1 discloses a dental instrument, which is provided for being introduced through the mouth into the oral cavity, whereby ultrasound can be locally applied to the surfaces of teeth in that location. The disadvantage of this disclosed apparatus, is that a physical contacting of the apparatus against the tooth is necessary, in order to clean the tooth. Beyond this, the introducing of the apparatus into the mouth and the targeted placing the apparatus against a tooth surface is complex and capable of error. This can lead to unsatisfactory results in the tooth cleaning.

Thus, the objective of the invention is to provide a process and a device allowing a reliable and simple cleaning of the tooth surfaces under the effect of ultrasound.

This objective is achieved by a process defined in claim 1, and a device defined in claim 8.

With the invented tooth cleaning procedure, an effect of sound (audible sound or ultrasound) is provided, wherein the said sound is transmitted to the teeth through a liquid in the oral cavity. The liquid can be, e.g. water, whereby the water can be mixed with abrasive additives (scouring or cleaning materials) for the purpose of increasing the effect of the tooth cleaning. In accordance with the invention, an application of the sound is provided on an outer side of the oral cavity. This offers the advantage that the application of sound is possible in a simple manner and without auxiliary means. Furthermore, the sound is reliably guided through the liquid in the oral cavity to all tooth surfaces enclosed by the liquid. In accordance with the invention, for the function of tooth cleaning, a tooth cleaning device with a sound generator is employed, which is adapted for being placed on an outer side of the oral cavity for the application of the sound. The tooth cleaning device can, for example, be provided with an application head, which is adapted to fit with the outer side of the oral cavity and thus reliably transmits the sound throughout a large area.

Preferably, the invented procedure for the cleaning of teeth is not used for surgical or therapeutic treatment. The particular advantages of the method are to be especially found in the cosmetic tooth cleaning, whereby the surface of the teeth is to be cleaned from adherent food remains or other materials.

Advantageously, on the outer side of the oral cavity, a sound transmitting coupling substance is arranged and the sound is applied via the coupling substance to the outer side of the oral cavity. This offers the advantage of a reliable transmission of the sound from the sound generator to the outer side of the oral cavity. Serving as a sound-transmitting coupling substance, for example, a gel known in the state of the art can be used.

Advantageously, a dispenser is positioned at the tooth cleaning device, which dispenser is capable of accommodating the sound-transmitting coupling substance and applying it on the outer side of the oral cavity. This offers particular advantages, if the dispenser operatively coacts with the sound generator, so that it issues the sound-transmitting coupling substance simultaneously with the emission of sound from the said sound generator.

Preferably, on the outer side of the oral cavity during the application of ultrasound, a scent substance can be supplied. This provides the advantage that the person (or animal) being subjected to the tooth cleaning procedure will have a more pleasant experience. For the supply of the scent, the inventive tooth cleaning device preferably comprises a reservoir for the scent and a scent applicator.

Advantageously, it is possible that for the generation of the sound, preferably in the audible vibration range, a motor with an imbalance can be used. This has the advantage that the generation of the sound can be made economically with very simple means. Further, for the generation of sound, preferably in the ultrasound frequencies, a piezoelectrical or a magnetostrictive vibratory generator can be used. An advantage of this latter arrangement is that the piezoeletrical or the magnetostrictive vibratory generator is very space saving.

Advantageously, at least one frequency of sound can be used, which is selected in the auditory or the ultrasound range and in particular in the range from 1 Hz to 1 GHz. Advantageously, it can be worked with a frequency in the ultrasonic range of 20 kHz to 100 kHz. Even the frequency ranges of 20 kHz to 40 kHz and from 20 kHz to 70 kHz can be satisfactorily applied. Particularly highly preferred is the range of 8 kHz to 45 kHz. The cleaning can be carried out e.g. at one single frequency within these ranges. Additional advantages for an optimal cleaning efficiency can be attained, if a frequency range is run through several fixed frequencies were used in a sequential manner or in parallel. If a generation of sound with different frequencies, e.g. continually altering frequencies, is taking place, then, in this way, it is possible that contamination can be removed with particular reliability and efficiency.

During an activity of auditory sound, preferably in the range of 16 Hz to 20 kHz, the liquid immersing the teeth preferably contains an abrasive additive. This abrasive additive could be at least one scouring or cleaning product, as these are usually found in toothpaste. The abrasive additive can also be used with the application of ultrasound cleaning.

The tooth cleaning device, which is an independent subject of the invention, is preferably made with a portable structure. Portability provides the advantage, that the use of the tooth cleaning device is particularly simple.

Advantageously, the tooth cleaning device possesses a receptacle for batteries, whereas the sound generator is battery-powered. Thereby, the manipulation of the tooth cleaning device is essentially made easier, since it has been thereby made free of wiring extensions and can consequently be used when travelling. The batteries can be of the recharging type. An inductive or a wire-bound charging can be provided. In accordance with the invention, it is also possible to provide a wire-bound use of the tooth cleaning device with a public service electrical supply.

Advantageously, the tooth cleaning device includes a transmission apparatus adapted for non-wired transmission of electrical energy. This has the result, that batteries in the sound generator can be recharged without wiring. Such a wireless transmission for example, can be so designed, that electricity is transmitted by means of induction, when the tooth cleaning device is arranged in a suitable battery charging station.

Advantageously, the tooth cleaning device comprises a water-tight casing and as a result, the device is capable of daily use under all circumstances and is protected from damage from the infiltration of water.

In the following, the invented procedure for tooth cleaning and the invented tooth cleaning device is more closely described and explained with reference to the attached drawing.

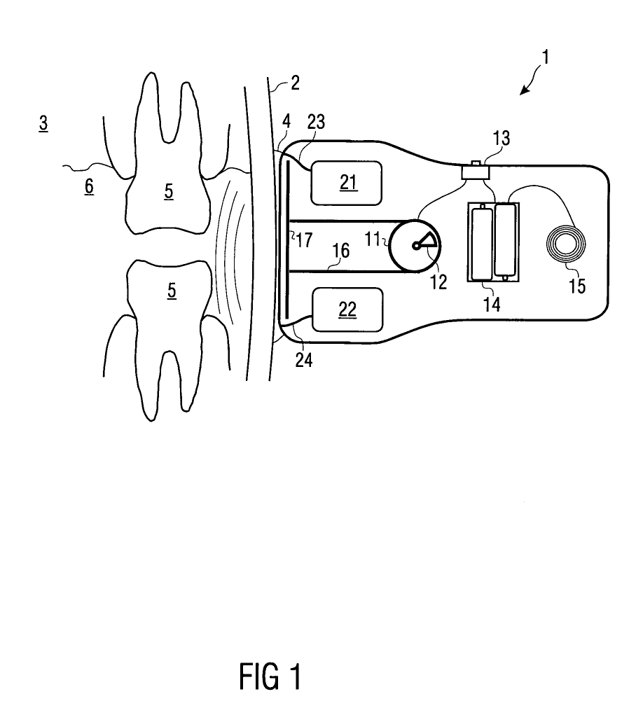

FIG. 1 shows a schematic presentation of an invented tooth cleaning device, which is so designed, that it can operate in the invented process for tooth cleaning.

The tooth cleaning device is described in an exemplary manner in the following with reference to a source of sound generation having a motor. The invention can be implemented in an analogous manner with other sources of sound such as, for example, a piezoelectric or a magnetostrictive vibratory apparatus.

In FIG. 1, an invented tooth cleaning 1 device is presented in a sectional view. The tooth cleaning device 1 is positioned on an outer side 2 of an oral cavity 3. Between the tooth cleaning device 1 and the said outer side, a gel 4 is provided, which is capable of transmitting sound from the tooth cleaning device 1 to the outer side. In FIG. 1 two teeth 5 are shown in sectional view, which are within the oral cavity 3. The oral cavity 3 is filled with water 6 to the extent that the freely exposed surfaces of the teeth 5 are completely immersed in the water 6. The water 6 serves for the transmission of the sound waves within the oral cavity to the teeth 5.

The tooth cleaning device 1 comprises a motor 11, the axis of which lies vertically disposed to the plane of the drawing. The motor 11 drives an eccentric cam 12 through an attached gear drive. The motor 11 can be switched on and off by means of a push button 13 and turns with a rotational speed of some 20,000 rotations per minute (RPM). The attached gear drive transforms the said RPM to suit the eccentric cam 12, in such a manner that this said cam rotates at approximately 40,000 rotations per second (RPS), which translates into 40 kHz of ultrasonic vibration. Where auditory sound frequencies are concerned, a lesser rotation speed can be provided and/or the gear drive can be omitted. The motor 11 is an electrically driven motor, for which the current supply is delivered through the push button 13 from a battery packet 14. For recharging the battery packet 14, an induction coil 15 is provided, through which electrical energy can be transmitted to the battery packet 14. Not shown in the drawing is an automatic charging apparatus for the said battery packet 14, which functions as it is commonly known in prior art.

The motor 11 with the attached drive and the eccentric cam 12 is mounted in a frame 16, which transmits the ultrasound waves developed by the eccentric cam 12 with the motor 11 onto a plate 17. The plate 17 serves the purpose of uniformly distributing, the ultrasound excitation over the entire surface area of the head of the tooth cleaning device 1. The frame 16 and the plate 17 consist of metal, while the housing of the tooth cleaning device 1 is made of plastic and is securely sealed against the entry of water. The plate 17 is bound rigidly with the front part of the housing of the tooth cleaning device 1. Thereby, a reliable transmission is assured for the ultrasound waves originating from the motor 11 to the housing of the tooth cleaning device 1. As has been described above, the gel 4 transmits the ultrasound waves from the tooth cleaning device 1 onto the outer side of the oral cavity 3.

Moreover, a scent reservoir 21 for a scent and a gel dispenser 22 for the gel 4 are arranged in the tooth cleaning device 1. The reservoir 21 is connected to a line 23, which delivers the scent from the reservoir 21 to the surface of the housing of the tooth cleaning device 1. The line 23 is, on its outlet side, equipped with a (not shown) pressure mechanism, which effects to an automatic emission of minimal quantities of the scent, when the tooth cleaning device 1 is pressed onto a surface, such as the outer side surface 2 of the oral cavity 3. In an analogous manner the gel dispenser 22 is connected to a gel-feed line 24, by means of which the gel 4 is transmitted from the gel dispenser 22 into an intermediate space between the tooth cleaning device 1 and the outer side 2 of the oral cavity 3.

The invention is not limited by the aforesaid description and explanation of a preferred embodiment. Much more a multiplicity of variants and changes remain possible, which, in a like manner, make use of the inventive concepts and on this account fall into the scope of protection.

1-17. (canceled)

18. A dental cleaning process, comprising transmitting a dental cleaning effective amount of sonic energy though a liquid in an oral cavity to teeth in the oral cavity, wherein the sonic energy is applied on an outer side of the oral cavity.

19. The process of claim 18, wherein the process is free of surgical and therapeutic treatments.

20. The process of claim 18, further comprising placing a sound transmitting, coupling substance on the outer side of the oral cavity, whereby the sonic energy upon the outer side is transmitted by the coupling substance.

21. The process of claim 18, further comprising delivering a scented substance on the outer side of the oral cavity while transmitting the sonic energy.

22. The process of claim 18, wherein the sonic energy is generated by a motor with an eccentric cam or with a piezoelectric or magnetostrictive vibratory generator.

23. The process of claim 18, wherein a frequency of the sonic energy is in a range of 1 Hz to 1 GHz.

24. The process of claim 18, wherein a frequency of the sonic energy is in a range of 20 kHz to 100 kHz.

25. A device for cleaning teeth comprising a sound generator, wherein the sound generator is adapted to be placed on an outer side of an oral cavity and transmit a dental cleaning effective amount of sonic energy though a liquid in the oral cavity to teeth in the oral cavity.

26. The device of claim 25, wherein the sound generator is portable.

27. The device of claim 25, further comprising a receptacle for retaining a least one battery adapted to drive the sound generator.

28. The device of claim 27, further comprising a transmission apparatus adapted to transmit electrical energy wirelessly, so that the at least one battery can be charged without wire connections.

29. The device of claim 25, wherein the sound generator is enclosed in a water-tight casing.

30. The device of claim 25, further comprising a reservoir for retaining a scented substance and a scent application apparatus for dispersing said scent.

31. The device of claim 25, further comprising a dispenser of a sound transmitting coupling substance.

32. The device of claim 25, wherein the sound generator comprises a motor with an off-center cam or a piezoelectric or magnetostrictive vibratory apparatus.

33. The device of claim 25, wherein the sound generator has an operational capacity in a frequency range of 1 Hz to 1 GHz.

34. The device of claim 25, wherein the sound generator has an operational capacity in a frequency range of 20 kHz to 100 kHz.
